(19) United States
(12) Patent Application Publication
(10) Pub. No.: US 2002/0129069 A1
(43) Pub. Date: Sep. 12, 2002

(54) Computerized dictionary for expressive language, and its vocabularies are arranged in a narrative format under each topic and retrievable via a subject-oriented index system

(76) Inventor: Zhixun Sun, Alhambra, CA (US)

Correspondence Address: Zhixun Sun, 2106 Cedar Street Apt G, Alhambra, CA, 91801, US

(21) Appl. No.: 09/756,004

(22) Filed: Jan. 8, 2001

(51) Int. Cl. G06F 17/24

(52) U.S. Cl. 707/532

(57) ABSTRACT

Contrary to traditional alphabetic-arranged dictionary, which is a reference tool for receptive language such as reading and hearing, my computerized dictionary is helpful resource for expressive language. Its vocabularies are arranged in a narrative format in the glossaries under each special topic and retrievable via a subject-oriented index system.

The information flow oriented in my dictionary and the steps of operation as following:

1. Initiates from the user's idea, or a desire to express, or want to share his feeling or the product of his thought with somebody else both in writing and speaking.

2. Embody the idea or the desire into a preset topic.

3. Retrieve a glossary of this topic via a subject-oriented index system or a search engine.

4. The narrative-arranged glossary will remind, enrich, and refresh the user's word power and expressive language to cover the preset topic

5. Retrieve the entries for detail reference. The user can click the words listed on glossary and hyperlinked to the its entry. The entries supply detail rhetoric reference with the plenty of modifiers, sample sentences, sample article, and sample document.

My dictionary and the glossaries can be used for the foreign-language translation. The glossaries can be the guideline of vocabulary selection and the resources of wording for translating the written material under a preset topic or field.

My dictionary and the glossaries also can be used as an independent word-processing software or a component of this kind of software.

### CROSS-REFERENCE TO RELATED APPLICATIONS

no applicable

### STATEMENT REGARDING FEDERALLY SPONSORED RESEARCH OR DEVELOPMENT

no applicable

### REFERENCE TO A MICROFICHE APPENDIX

(no applicable)

### BACKGROUND OF THE INVENTION

U.S. Patent Classification Definitions

Class 704 Data processing: Speech signal processing, linguistics, language translation, and audio compression/decompression.

subclass: 10 Dictionary building, modification or prioritization:

Under subclass 1. Subject matter including a construction, hierarchies, a change, or an orderly arrangement of dictionary, thesauri, or the like.

### DISCUSSION OF PRIOR ART

There are a variety of dictionaries available for people to get the reference information about the vocabularies, such as the conventional alphabetical-arranged dictionaries (with their electronic versions), thesaurus, and encyclopedia, etc.. But all of the dictionaries are designed to be a reference tool for receptive language only, such as reading and listening. Those conventional dictionaries have the some disadvantages and limits:

A. Only for reading, little help for writing. A conventional dictionary is designed to help the user to reading, he can check out a new word on a book and find out its definition and then understand the meaning of the sentence. But when composing a letter, drafting a document, or orally elucidating a situation, or debating on an issue, people can not get any substantial assistant from those dictionaries. If the user can not spell the word out correctly at first, he still is helpless with those dictionary.

B. Puzzle about polysemy. It is inconvenient and time consuming for a user to find out the right definition from a polysemous entry in the conventional dictionaries. Most words have several, even more than dozens of definitions, to find the right one will depended upon the parts of speech, the context and in which subject or in which field involved. Refer REFERENCE 1 Entry “service” of a conventional dictionary. It has 37 definitions.

C. One search effort retrieves one entry only. The user can retrieve only one entry upon a search effort from the conventional alphabetical-arranged dictionary. There is no any natural and practical relationship among the alphabetical arrangement, and all words needed to cove a topic are scattered randomly (alphabetically) in several thousands pages of a dictionary, It is almost impossible to retrieve them out timely and efficiently when people want to write or speak about a special topic, or prepare a special glossary for the communication in a some situation, such as in a court or in a hospital.

As a reference tool for receptive language, the alphabetically-arranged dictionary just help people's reading well, but people also need a new dictionary to enrich their expressive language. Many educators believe that the express language is much more important than receptive language for our children' successes.

### BRIEF SUMMARY OF THE INVENTION

The object of this invention is to provide a vocabulary reference tool especially for people's expressive language, such as in writing and in speaking. The computerized dictionary invented consist of

(1) A subject-oriented index system. The subjects are in the first prioritization in this index system. Each catalogues of topics are affiliated their subjects, following the system, the user can easily retrieve a glossary that is useful to cover a topic or a situation he interested.

(2) The narrative-arranged glossaries. The vocabularies in my dictionary are arranged in a narrative format in each glossary under each concrete topic. The narrative arrangement reflects the natural relationship of the words and follows the actual way how those words be used in expressive language. With those glossary, the user can check the spelling of the words and refresh or enrich his wording power.

(3) The entries. The user can click the words listed on the glossary, and retrieve the entry of the word for more detail reference. The entries in my dictionary present only one right definition serve the preset topic, but with have more derivatives, sample sentences, keyword cross reference, or even a sample article to supply enough reference for expressive language.

(4) A combination of software programs and electronic technique. The combination of technique can help the user get dynamic vocabulary reference faster and more efficiently. It include a cataract-style display of the major catalogue, sub-catalogue, and detail-catalogue, hypelinked-cross reference, and some customizeable edition function to help user's study and memory, such as “short cut”, “history”, “a tool of wording” etc..

### DETAILED DESCRIPTION OF INVENTION

### General Design

When people want to effectively express themselves, such as in writing or in speaking, a preset topic or a limited field must be acknowledgeable both for author and reader, or speaker and listener. To organize those individual topics into a subject-oriented index system, and to arrange the vocabularies in a narrative format in the glossaries under each topic with modem computer technique, I invented a dictionary for expressive language.

### The Components and Their Function

The dictionary for expressive language comprising:

A. A subject-oriented index system comprising

(i) A subject index. Referring to SAMPLE PAGE I, Subject index subject-oriented index system: subject index.

In “the subject index”, the items of content are formated into 2 columns. The index column alighted right is “subject column” in which list 17 subjects from “human” at top to “university” at bottom. The index column alighted left is “topic column”, in which list the major catalogues of topic that affiliated to the subject which is listed on the right column at its upper lever. For example, the topic of “life circle” affiliated to the subject “human”.

The definition of “subject” in my dictionary is an entity who can initiates actions, own property, withhold sub-subjects, or interact with other subjects. For example: “human” (a subject) lead a variety of “lives” (topic) and have a lot of “property” (topic). “country” ( a subject) declare “war” (topic) against each other and carry out the “foreign policy” (topic).

The definition of “topic” in my dictionary is any issue, theme, situation, activity, phenomena, process, or anything which people have interest to talk about it. for example: art, business, or basketball game.

The subjects are in the first prioritization in this index system and are the leading keyword for retrieving the topics. Although there are infinite things in our world and incalculable phenomena in the university, but only subject, such as “human”, “country”, can initiate the actions, own property, interact with other subjects, and withhold the sub-subjects. Because the affiliation relationships between the subjects and their topics is very clear in everybody's mind, it is very easy and directly to follow the subject-oriented index to reach the topic he interested and retrieve out a glossary of this topic.

(ii) Major catalogue of topics. Referring to SAMPLE PAGE 2, Catalogue of family subject-oriented index system: subject index >family> the catalogue of family.

Any word listed in both the subjects column and the topics column in subject index can be clicked and pop out (cascading display) a sub-catalogue of topics. Similar to the subject index, on the index column aligned left listed individual topics, such as “family members & relatives” “adaptation,” “family trees,” etc.. On the index column aligned right listed the title of sub-group of topic, such as “family,” “family affairs,” “family cycle.” The right column is for quick review. The left column is for detail review.

(iii) Sub-catalogue of topics. Referring to SAMPLE PAGE 3, Sub-catalogue of art subject-oriented index system: major-catalogue of topics>sub-catalogue of art's topics.

Any item listed subject index and major catalogue can be clicked and pop out (cascading display) a sub-catalogue of topics. The sub-catalogue of topics is also formated in 2 columns as mentioned above. As need of content, more detail catalogue can be created and affiliated to the major or sub-catalogues. The arrangement of the catalogues and the topics reflects scientifically the structure of our knowledge system.

(iv) Detail catalogue of topics, Referring to SAMPLE PAGE 4: Detail catalogue of drama subject-oriented index system: major-catalogue of topics>sub-catalogue of topics>detail catalogue of drama

Detail catalogues are also formated in 2 columns as mentioned above. Any topic listed in the catalogues can be clicked out, and retrieved a glossary of this topic. Usually, many topics will be listed in more than one catalogue, result in a lot of overlap and repetition that used to be a headache task for the editors of the printed dictionary. But compiling those catalogue and topics through hyperlink technique and with the powerful computer memory is quite easy. These catalogues will be created as complete, perfect and convenient as possible for the user to access.

B. A conventional search engine. A conventional search engine is available for the user to directly type the name of a topic into and retrieve a glossary of this topic. The user can not retrieve directly a entry as conventional electronic dictionary does, because the entries in my dictionary only present one definition which serve its topic and without any independent entry with all its definitions.

C. The Narrative Arranged Glossaries

Referring to SAMPLE PAGE 5, Glossary of Wedding and SAMPLE PAGE 6, Glossary of Election.

The path to retrieve the glossary of “wedding” is: Family(subject)—Family affair(catalogue of topic)—Wedding (glossary) .

The path to retrieve the glossary of “election” is Country (subject)—Domestic affairs (the title of the group of topics)—Election (glossary)

Through the subject-oriented index system, the user can retrieve a glossary (may have more than a hundred words) to cover the topic he interested. Unlike alphabetic arranged dictionary, the vocabularies in my dictionary are arranged in a narrative format in each glossary under each topic. The narrative arrangement reflects the natural relationship among the words and follows the actual way how those words be used in the expressive language and the sequence of the development of an event.

Abbreviations. At first, let me introduce the abbreviations used in my dictionary: abbreviations

| | stand for: | sample word |
|---|---|---|
| tp | topic | wedding |
| a | adjectives | fanfare, luxury |
| syn | synonyms (separated with “, “) | quite crowd, fanfare |
| ant | antonym (separated with 5 space) | simple luxury |
| p | personal, staff, parties, officers, | bride; groom; emcee |
| | experts, or any characters of a topic | witness of wedding |
| o | organization | single club |
| ps | the parts of the subject | face, hand (of the body) |
| v | verbs | espouse |
| ad | adverb | lively; bustlingly |
| d | document | marriage certificate |
| w | where the event happen, | church |
| | building, background, or situation | bridal chamber |
| t | time, date, calendar, schedule | lucky day; wedding day |
| e | equipment, tool | sedan chair |
| pr | procedure | fetch bride; give away the |
| | | bride |
| ac | actions, events | exchange the vows, walk |
| | | down the aisle |
| rs | result, end | consummation |

Generally, the words in the glossary will list in the sequence mentioned above. e.g. from tp at top—rs at bottom. In the glossary, all of the abbreviations and the titles of group of words are aligned right to form an express view column to help the user easily and quickly locate the word he or she interested. All individual words and terms are aligned left to form a detail view column. When there are a significant change in meaning of the words or a beginning of group of words, the first word in next group will be bold to indicating this change.

Most commonly, the narrative arrangement follows the natural development of the event, such as from the begging to the end. e.g. “wedding”. from propose—consummation. As a rule, the adjectives are arranged next to its subject, and the verb follow by adverb. The parts are under the whole. The narrative arrangement can varied and be modified depended upon the different topics. It can be emphasized in a scientific style for a medical topic. It also can be emphasized on the relationship for a family member topic.

Like a drama script, the narrative arrangement has its essential components and basic format upon which a writer can compose infinite pieces of plays. Please view the analogues between them and get a better understanding of the narrative arrangement:

| | the abbreviations |
|---|---|
| the components of drama script | in narrative arrangement |
| theme | tp |
| roles | p |
| scenes | w |
| date | t |
| stage property | e |
| prolog, plot, | pr; ac |
| end | rs |

The subject-oriented principle is also carried out in the glossary compiling. The subjects are also the main lines of the a glossary structure.

The glossary will well serve the demands of reminding, enriching, and spelling-checking of the vocabulary which are useful to cover its topic in expressive language. If the user want get more detail reference of a word, he can click the word listed in the glossary, and retrieve its entry.

D. Entry

Refer to SAMPLE PAGE 7 Entry of “franchise”

The entries in my dictionary supply all word's reference information as the conventional dictionary can, and emphases on supplying enough reference for writing. But the entries in my dictionary usually present one right definition that directly serve its topic. For example:

governor may be a chief officer of a state, or a regulator to control the speed of a engine.

Bu under the topic “engine”, governor only means a speed regulator.

Refer to SAMPLE PAGE 8 the entry of “governor” in conventional dictionary

Refer to SAMPLE PAGE 9 the entry of “governor” in my dictionary

My entries supply plenty of example sentences, the derivatives, the common modifiers, keyword cross references, even sample article, sample document. Refer to SAMPLE PAGE 10, The entry of “Invitation” The items in the entry include:

word

root just indicated by “__” e.g. remediable; refreshment

pronunciation

parts of speech (such as noun, verb, or adverb, adjective)

definition (usually present one)

modifiers (the verbs, adverbs, and adjectives to modify the entry word. and with their sample sentences)

example sentences

illustration (optional)

derivatives (with their example sentences)

cross reference, (via hyperlink keywords)

example article, document, practical writing, or letter

Operation and Connection. The information flow guide by my dictionary is start from

1. Idea and desire to express. If an idea corn out from your mind, and you want to share it with somebody else, or you want to write a letter, or article, or prepare for a communication in special situation, here come out a demand of active-expression.

2. Retrieve the glossary. Through the subject-oriented index system.

Just figure out who is the subject of your idea, and what catalogue your topic belong to, then follow the subject-oriented index system, you can easily reach the catalogue of topics, and click it and retrieve a glossary (may include more than hundreds words) to cover this topic. The retrieving path as following:

for example

| A. | an idea, a desire to express about the topic of “wedding” | |
|---|---|---|
| B. | Subject index | family (one of the subjects) |
| | connected (C) with cascade display | |
| C. | Catalogue | family |
| | connected (D) with cascade display | |
| D. | Sub-catalogue | family affairs |
| | connected (E) with hyperlink | |
| E. | Topic | wedding |
| | connected (F) with hyperlink | |
| F. | Glossary | wedding |
| | connected (F) with hyperlink | |
| G. | Entry | wedding (the end of information flow) |

Through the search engine. Another direct path to retrieve the glossary is through a search engine. Directly type the name of the topic into the search engine, and immediately retrieve the glossary of the topic. The glossary will address the demands of reminding, refreshing, enriching, and spelling-checking of the vocabularies which are useful in expression of the topic.

3. If the you want to get more detail reference of a word, you can click the word listed in the glossary and retrieve the entry of the word.

I claim:

1. A computerized dictionary for expressive language comprising:
(a) A subject-oriented index system. In said index system, the catalogues of topics, sub-catalogues of topics, and detail-catalogues of topics are organized under the subjects which they affiliated to.
(b) A conventional search engine. The user can type the name of topic into said search engine and retrieve the glossary of this topic.
(c) The narrative-arranged glossaries of said topics. Said glossaries arranged in a narrative format under the said topics.
(d) The entries. Said entries of the words listed in said glossary and has usually one definition serve the said topic straightforward. Said entries include keyword cross-reference, its modifies, sample sentences, sample article, sample document which supply rhetoric reference for expressive language.
Interconnections:
In said index system
(i) the subjects index and the catalogue of topics
(ii) the catalogue of topics and the sub-catalogue of topics
(iii) the sub-catalogue of topics and detail catalogue topics are connected via a cascading (pop out) display
The catalogue of topics and their glossaries are connected via hyperlink.
The words listed in the glossaries and their entries are connected via hyperlink.
The keyword cross reference among the entries are connected via hyperlink.

2. The dictionary of claim 1 wherein: said index system comprising

3. A subject index including a major catalogue of human activities.

4. The catalogues of topics which is formated in two columns. The individual topics are listed in the column aligned left form a detail view column. The column aligned right is an express-view column in which list the titles of the group of topics.

5. The sub-catalogues of topics which also are formated in two said columns.

6. The detail-catalogues of topics are foramted in two said column.

7. The dictionary of claim 1 wherein: said search engine can retrieve the glossaries of said topic, both from the whole database of topics and from the catalogues of topics or a sub-catalogue of topics.

8. The dictionary of claim 1 wherein: said glossaries are arranged in a narrative format for the user's to easily access the vocabularies useful for his or her expressive language. Said formats have been adjusted and modified for better serve the various topics. Said glossaries are also formated in double columns. In the column aligned left listed individual words. The column aligned right is a express-view column, in which listed the titles of group of words and abbreviations that help the users quickly access the vocabularies they need.

9. The dictionary of claim 1 wherein: Said entries of word usually has one definition serve said topic straightforward. Said entries supply the detail rhetoric reference with plenty of the modifiers, sample sentences, sample article and sample document. Several keywords hyperlink to other relevant entries.

10. The dictionary of claim 1 wherein: said dictionary and all of said glossaries, used as a reference tool for language translation, or incorporated in any automatic translation program, software, device and apparatus.

11. The dictionary of claim 1 wherein: said dictionary and all of said glossaries, use as a reference tool, or an integrated part of the word-processing software.
